(19) United States
(12) Patent Application Publication
(10) Pub. No.: US 2006/0028430 A1
(43) Pub. Date: Feb. 9, 2006

(54) Video device integratable with jacket, pants, belt, badge and other clothing and accessories and methods of use thereof

(76) Inventors: Franz Harary, Los Angeles, CA (US); Vincent Guadagnola, Spring, TX (US)

Correspondence Address: ARENT FOX PLLC, 1050 CONNECTICUT AVENUE, N.W., SUITE 400, WASHINGTON, DC, 20036, US

(21) Appl. No.: 11/157,159

(22) Filed: Jun. 21, 2005

Related U.S. Application Data
(63) Continuation-in-part of application No. 11/081,813, filed on Mar. 17, 2005.
(60) Provisional application No. 60/580,735, filed on Jun. 21, 2004.

(51) Int. Cl. G09G 5/00

(52) U.S. Cl. 345/156

(57) ABSTRACT

Wearable multimedia delivery devices and methods of use thereof. A first variation provides a video jacket incorporating multimedia information delivery and optionally including separate power and multimedia information sources so as to minimize restriction of motion for the wearing user. In one variation, the separate power and multimedia information sources are provided on a belt coupled to a multimedia delivery component. Another variation provides a video badge wearable by a user, for example, when delivering a service, such as waitering. A third variation provides a video belt wearable by a user, for example, when deliverying a service, such as waitering. Other variations are provided for other wearable video options. Additional features include impact resistance and heat dissipation.

This application is a continuation-in-part of applicant's copending U.S. patent application Ser. No. 11/081,813 titled “VIDEO BELT AND BADGE AND METHOD OF USE” filed Mar. 17, 2005, and claims priority to applicant's copending U.S. Provisional Patent Application Ser. No. 60/580,735 titled “WEARABLE VIDEO DEVICES AND METHOD OF USE” filed Jun. 21, 2004. The entirety of each of these patent applications is incorporated herein by reference.

### BACKGROUND OF THE INVENTION

1. Field of the Invention

The present invention relates to wearable display devices, and in particular to jackets, pants, belts, badges, and other clothing and accessories that are wearable and that allow display of video information.

2. Background of the Technology

There remains an unmet need in the art for advertising and expression via individual users, and in particular to new devices and methods allowing individual expression. There is a further need for such methods and devices to provide new and eye catching advertising platforms, which will be noticed by an ever more jaded and overexposed audience.

In the past, the technology has not been available to place video advertising into a display small enough to be worn by a person. Although graphic badges, buttons, name tags and patches have been around for many years, none of the prior art has previously provided the opportunity for an advertiser to present an infinite amount of information to the consumer and public in an advertising platform utilizing wearers.

### SUMMARY OF THE INVENTION

For thousands of years mankind has looked to express himself via personal statements. This is predominantly executed in the form of fashion. Be it clothing, jewelry, make-up, hair styling, body modification, such as tattooing, or any kind of worn accessory.

This sense of style and personal communication has been prominent as early as in Roman times. To state that fashion is an expression of personal ideas and passions is quite simply exploring the obvious. One important element, however, has acted to shape the way human beings communicate personal beliefs and personalities. That element is technology. Every time a new method arrives for producing textiles, accoutrements or accessories, this resource is embraced by fashion designers and employed by them to express personal style. One major leap forward was the invention of silk screening in the 1950's. This meant that clothing makers could print on garments cost effectively, thus allowing a whole new demographic of people to express themselves with graphic images, statements, messages, etc.

As technology advances, so does fashion and personal expression. A need has developed to integrate digital technology into fashion. However, only recently has video technology become compact, self-contained, portable and affordable enough for consumer fashion. With the advent of liquid crystal display (LCD) monitors and silicon chips powerful enough to drive the production of video imagery, among other developments, the personal video screen accessory provides the next natural progression in the quest for personal expression.

Apparel and accessories can now be integrated with a video display (also interchangeably referred to herein as “screen” or “monitor”) so that individuals (also interchangeably referred to herein as “users”) are able to wear functioning video. The video displays may be made, for example, in the form of small LCD monitors that are self-contained, battery operated and easily maintained by the individual. In addition, the devices are designed to be capable of playing video and audio programming. In one embodiment, the video display is approximately five inches high by seven inches wide and less than one inch thick, and is lightweight and durable enough, and contains specialized features, so as to withstand wear and tear of normal use. Other embodiments use video displays of varying dimensions, such as dimensions generally comparable to personal digital assistants and Pocket PC's (collectively known as “handhelds”).

Embodiments of the wearable video device include a color LCD display controlled by a processor (e.g., a microprocessor) that is run, for example, in a Windows® Pocket PC operating system made by Microsoft® Corporation of Redland, Wash. It should be noted that devices running on comparable operating systems, such as a Palm® operating system, made by PalmSource™, Inc., of Sunnvale, Calif., can also be used. In this variation, images are stored in memory and displayed, for example, at a rate of about 24 frames per second. This rate may be varied in accordance with the capabilities of the technology. In one variation, power comes from an onboard battery.

One embodiment of the present invention provides a “video jacket” or “media jacket” that allows communication of multimedia information worn on a jacket. Embodiments of this variation of the present invention include, for example, a jacket-vest combination with integrated lightweight liquid crystal display (LCD) technology, speakers, batteries and a digital video disk (DVD) player or other multimedia information source, which together create advertising or other multimedia presentation space via a wearer or wearers, such as roaming models in high-density public spaces.

Another embodiment of the present invention provides a first securable video device, referred to interchangeably herein as a “video belt.” Embodiments of the video belt of the present invention include a self-contained LCD video screen preprogrammable to play video/audio information that is intended as personal expression or public advertisement.

Another embodiment of the present invention provides a second securable video device, referred to interchangeably herein as a “video badge.” Embodiments of the video badge include a small self-contained video display designed to be worn, for example, publicly by service personnel as a new advertising platform aimed at consumers or worn by individual users wishing to provide a new medium of expression.

Yet other embodiments include video pants and other clothing. The present invention also includes other features relating to worn video, such as devices, mechanisms, and systems for minimizing adverse impacts, including physical impacts, on the video portion of the invention, and for enhancing heat dissipation.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 is front view of an exemplary embodiment of the video motorcycle jacket, wherein the video screen is disposed at the chest area of the jacket, in accordance with an embodiment of the present invention;

FIG. 2 is a side view of an exemplary embodiment of the video motorcycle jacket, wherein the video screen is disposed at the chest area of the jacket, in accordance with an embodiment of the present invention;

FIG. 3 is a back view of an exemplary embodiment of the video motorcycle jacket, wherein the video screen is disposed at the chest area of the jacket, in accordance with an embodiment of the present invention;

FIG. 4 is a front view of an exemplary embodiment of the video jacket, wherein the video screen is disposed on the back of the jacket, in accordance with an embodiment of the present invention;

FIG. 5 is a back view of an exemplary embodiment of the video sjacket, wherein the video screen is disposed on the back of the jacket, in accordance with an embodiment of the present invention;

FIG. 6 is a front view of an exemplary embodiment of the video jacket, wherein the video screen is disposed on the back of the jacket, in accordance with an embodiment of the present invention;

FIG. 7 is a back view of an exemplary embodiment of the video jacket, wherein the video screen is disposed on the back of the jacket, in accordance with an embodiment of the present invention;

FIG. 8 is a front view of an exemplary embodiment of the video jean jacket, wherein the video screen is disposed on the back of the jacket, in accordance with an embodiment of the present invention;

FIG. 9 is a back view of an exemplary embodiment of the video jacket, wherein the video screen is disposed on the back of the jacket, in accordance with an embodiment of the present invention;

FIG. 10 is a front view of an exemplary embodiment of the video jacket, wherein the video screen is disposed on the back of the jacket, in accordance with an embodiment of the present invention;

FIG. 11 is a back view of an exemplary embodiment of the video jacket, wherein the video screen is disposed on the back of the jacket, in accordance with an embodiment of the present invention;

FIGS. 12 and 13 show views of an exemplary video belt, in accordance with embodiments of the present invention;

FIG. 14 is a front view of an exemplary embodiment of the video belt, wherein the video screen is disposed in the center of the belt, in accordance with an embodiment of the present invention;

FIG. 15 illustrates an embodiment of the video belt as being used by a human female, in accordance with an embodiment of the present invention;

FIGS. 16-19 present various views of exemplary video badges and components, in accordance with embodiments of the present invention;

FIG. 20 is a front view of an exemplary embodiment of the video purse, wherein the video screen is disposed facing an outer wall of the purse and a control flap allowing access to the video control panel is disposed below the video screen, in accordance with an embodiment of the present invention;

FIG. 21 illustrates an embodiment of the video purse as being used by a human female, in accordance with an embodiment of the present invention;

FIG. 22 is a front view of an exemplary embodiment of the video portfolio, wherein the video screen is disposed facing an outer wall of the portfolio, in accordance with an embodiment of the present invention;

FIG. 23 is an exemplary embodiment of the back of the video portfolio, in accordance with an embodiment of the present invention;

FIG. 24 is a front view of an exemplary embodiment of the video pants, wherein the video screen is disposed at the thigh of one leg of the pants, in accordance with an embodiment of the present invention;

FIG. 25 is a back view of an exemplary embodiment of the video pants, wherein the video screen is disposed at the thigh of one leg of the pants, in accordance with an embodiment of the present invention;

FIG. 26 is a front view of an exemplary embodiment of the video pants, wherein the video screen is disposed at the thigh of one leg of the pants, in accordance with an embodiment of the present invention;

FIGS. 27-29 show views of impact resistant mechanisms and features for a video device, in accordance with one embodiment of the present invention;

FIGS. 30, 30A, 31, and 32 show views of impact resistant mechanisms and features for a video device, in accordance with one embodiment of the present invention;

FIGS. 33-36 show views of impact resistant mechanisms and features for a video device, in accordance with one embodiment of the present invention; and

FIG. 37 contains a representative diagram of exemplary computer system components and features for use in accordance with the present invention.

### DETAILED DESCRIPTION

The present invention relates to video jackets, pants, badges, belts, and other apparel and accessories, and methods of use thereof.

One embodiment of the present invention provides a video jacket (also interchangeably referred to herein as a “media jacket”) that is wearable and includes a multimedia component, such as video information. In one exemplary variation, the media jacket comprises a leather jacket with removable vest sleeves. The jacket of this variation is stylized in the genre of high-tech futuristic motorcycle wear. The jacket embodiments of the present invention include all styles and types, such as motorcycle, bomber, athletic, or trench. Other variations provide different styles to be worn by both men and women, depending on the venue and application.

In some embodiments, the apparel includes reinforced material to maintain the video screen in a generally fixed position. Reinforcement is accomplished using, for example, stitched material, fasteners or other methods or devices. The video screen is secured at any location on the apparel, including, but not limited to, the chest, sleeves, lower torso, or back. The material of the apparel includes any that are sufficiently strong to hold the video screen to the apparel. The screen may be secured in any of a number of ways.

In one variation, the apparel includes an outwardly opening pocket (also generally referred to herein as “outwardly disposed”), wherein a transparent material is affixed to the outer fabric of the apparel. The pocket construction of some variations includes sides and a bottom affixed to the outer material of the jacket. Thus, at least one side, such as the top, allows insertion of the video device in and out of the pocket.

In another variation, the apparel includes an inwardly opening pocket (also generally referred to herein as “inwardly disposed”). In this variation, a portion of fabric of the apparel, which corresponds approximately to the size of the video screen, is removed from the apparel. Generally, a transparent material, such as clear plastic, having a surface area slightly greater than the area of the removed fabric, is affixed to the apparel, for example, by stitching or chemical adhesion. On the inner lining of the apparel, a material, which is generally not smaller than the size of the removed fabric, is also affixed to the apparel so that three sides of the material are affixed and a pocket is formed. The pocket allows the video screen to be removed as necessary. The material used for the pocket can be any suitable material, as long as, for example, the material is strong enough to secure the video screen in place and support its weight.

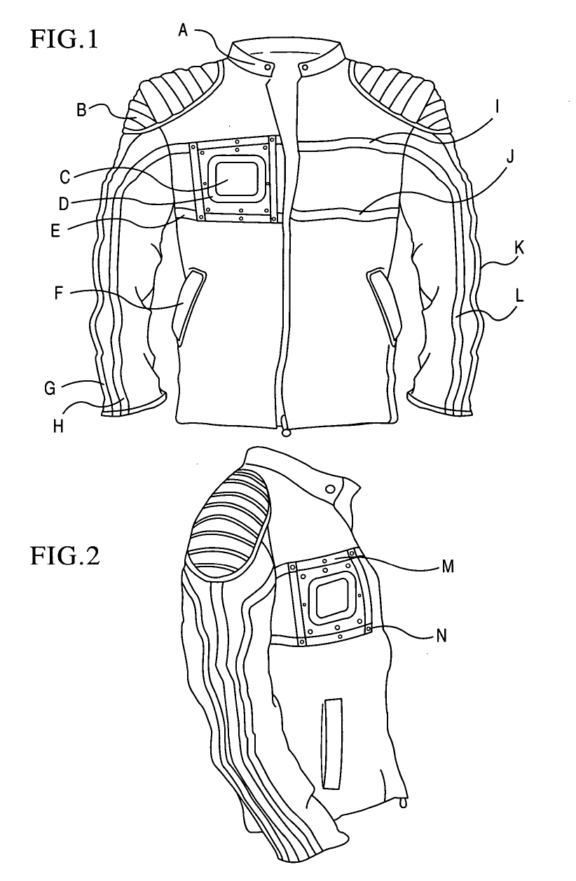

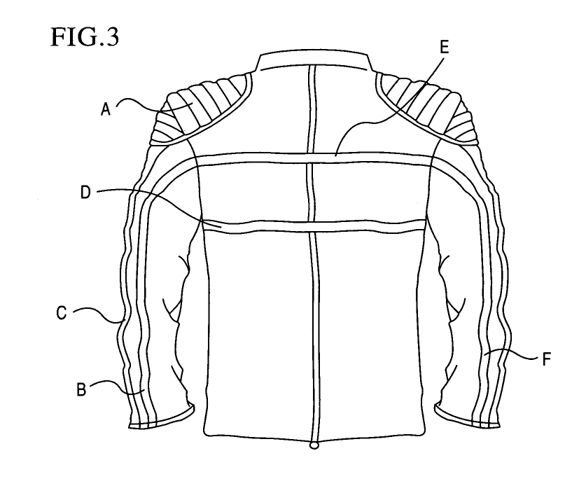

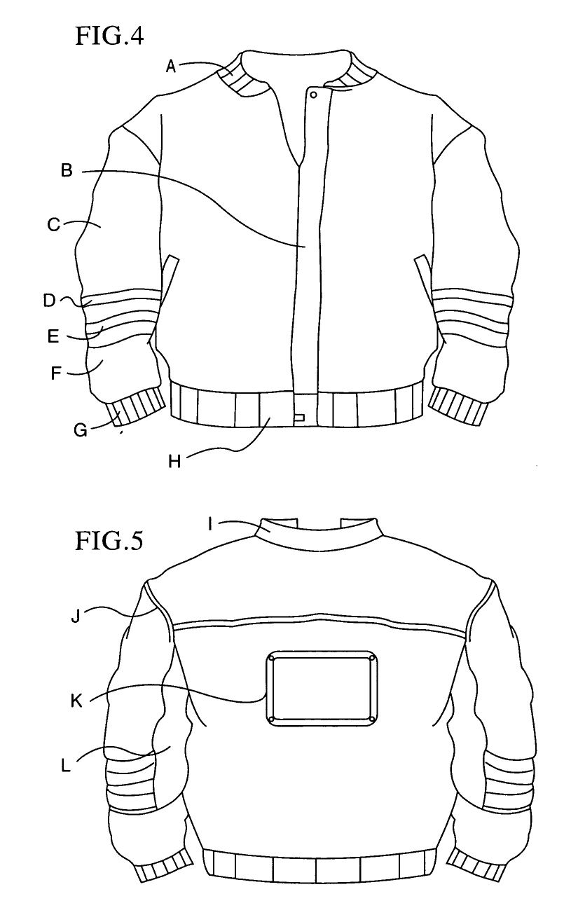

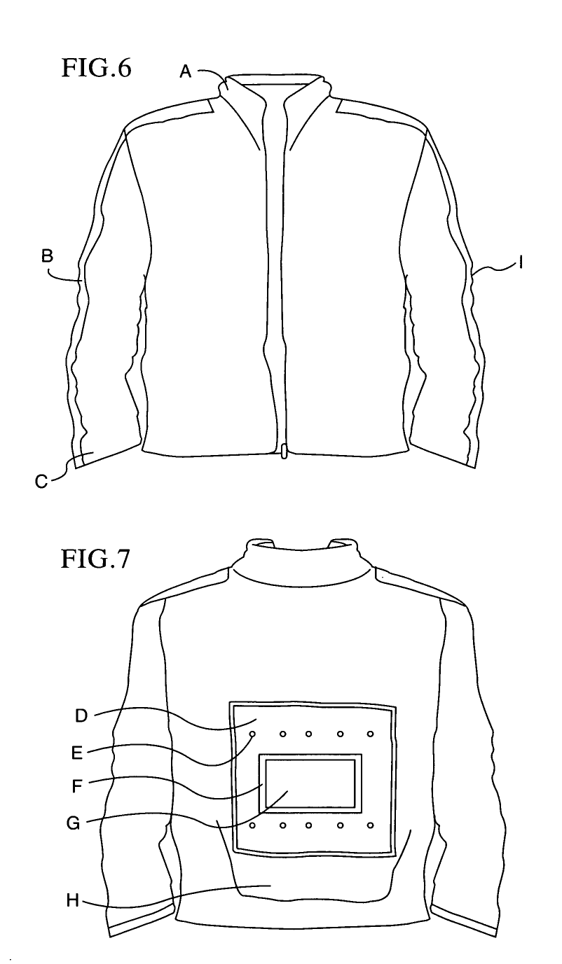

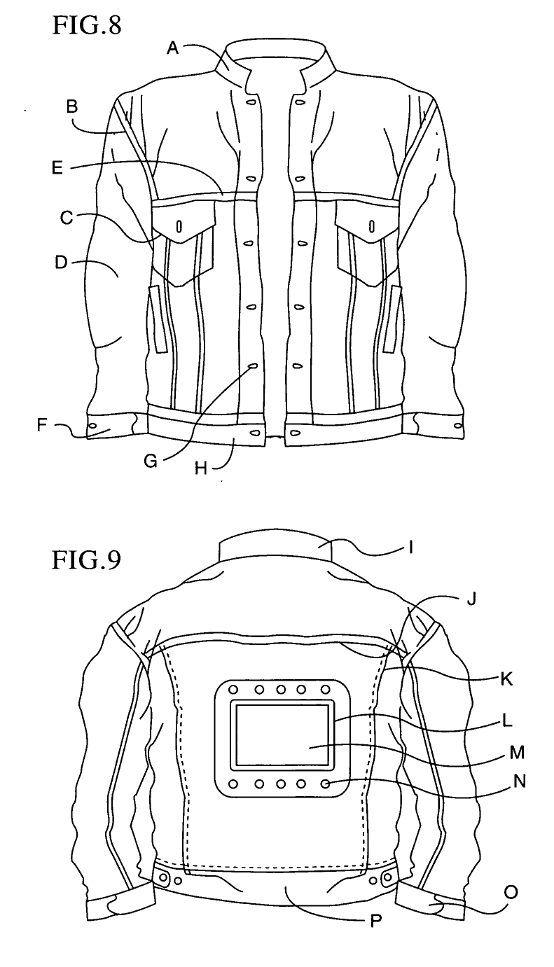

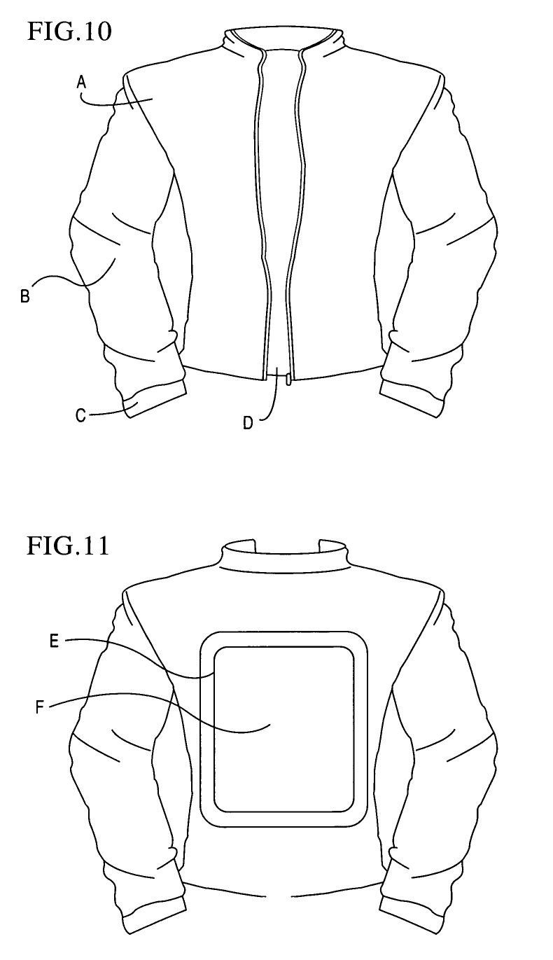

In one variation, as shown in FIGS. 1-3, the video screen is displayed on the chest of the jacket. The pocket is outwardly disposed and is reinforced using the seams of the jacket. In another variation, as shown in FIGS. 4 and 5, the video screen is displayed on the back of the jacket. The jacket may display, for example, video shots of sports teams embroidered or stitched on the jacket, thereby allowing further individual expression. FIGS. 6 and 7 illustrate a third variation of the video jacket in which the video is also displayed on the back of the jacket. The video screen of this embodiment is secured by an outwardly disposed pocket, in the variation illustrated. FIGS. 8 and 9 illustrate a video jean jacket having the video screen on the back of the jacket. The pocket securing the video screen is illustrated as being inwardly disposed in FIG. 9. FIGS. 10 and 11 illustrate another variation of a jacket that accommodates a large video screen on the back of the jacket.

In one embodiment, the media jacket has contained within it a multimedial delivery portion, such as an LCD monitor optionally coupled to or incorporating a speaker or speakers. This monitor is powered by one or more batteries.

In some variations, the media jacket also contains one or more infrared beams. These beams are coupled to, for example, a microprocessor, which in turn communicates with a circuit allowing for the continuous tally of information during a preset period of time. For example, these features may provide information on the number of people who stand within a predetermined radius (e.g., four feet) of the jacket, as well as the amount of time that they remain within the range.

Audio and video are driven via a multimedia source portion, such as a DVD player/chip or other multimedia storage and delivery platform, that is coupled to or incorporates a power supply, such as one or more batteries. In general, most variations of the jacket are lightweight and designed with components so as to be serviced easily. In some variations, the media presented via the jacket is formatted so as to allow maximum visibility and attention in whatever public venue the jacket is worn.

One exemplary innovative service that the jacket of the present invention is able to provide is the ability to reach a customer base that has to date been completely inaccessible, such as those present at a rave scene, highly private events such as the Oscars® and Emmy's, as well as sporting or concert events.

One service that the “media jacket” of embodiments of the present invention is able to provide is presentation of advertising or other information similar to that which had been solved in the past via television or radio advertising, print advertising and public signage, such as billboards, posters, fliers, and even skywriting. Thus, similar to the advent of skywriting, for example, the form of advertisement providable by the present invention was not available until the invention of certain features, such as small, inexpensive video components.

More specifically, the present invention delivers the ability to bring advertising to the public in a new way via technologies that have only recently become conducive to such applications (specifically, the video hardware has become lightweight and dependable enough to be integratable into wearable clothing, and the psychological principles pulled from illusion design that has been applied to the apparel design allow for a seemingly minimal garment).

One reason the ability to use video as a viable element in personal apparel advertising has not been viable in the past is because of the substantial amount of electronics and the weight required for the final product to function. It is the present invention's unique reconfiguration of an LCD screen, along with design psychologies derived from, for example, the inventor's magical illusion designs, which allow for a piece of apparel that, although apparently small in size, secretly holds the substantial amount of electronic equipment required for the video effect to operate. In some embodiments, one functional difference is in the art design. By using lightweight technologies and by orienting the LCD video screen parallel to the length of the media jacket, the present invention maximizes the video surface on the jacket back. It is this optical illusion that allows the media jacket of some variations to be worn by, for example, female models who are not particularly strong, yet possess the professional talent to attract large groups of people.

The jacket and other wearable variations of the present invention can be used to advertise both service and products and for direct point of purchase sales anywhere. For example, Las Vegas casinos can promote their shows or casino specials on the casino floor. Soft drinks or any other food items may be advertised in the stands of sporting events. The jacket's use can be applied to virtually any other product in existence and can also be produced for retail sale and sold as high-end fashion apparel. The attention and public focus it generates continues uninterrupted to the extent of the available battery time. Without a doubt, the present invention has the ability to capture an impromptu audience in any public place. Ultimately, this will become one use of the present invention when employed, for example, by advertising agencies.

The media jacket of some embodiments is also very user-friendly. Its design, derived in some variations from a motorcycle jacket, for example, with extensive use of Velcro® and access zippers, allows all of the electronics to be easily accessed for repair, maintenance, and cleaning of the jacket itself. The design also actively ventilates the interior, allowing for all of the electronics to maintain a temperature conducive to their function, where necessary.

The video belt variation, in one embodiment, is a fashionable belt made in numerous styles for both men and women that features one or numerous video elements. Specifically, in one embodiment, the video displays come in the form of small LCD monitors. These monitors are self-contained, battery operated and easily maintained by the user.

The video screen is attached to the belt using a securing device, such as a fastened pocket, to maintain the video screen in a generally fixed position relative to the wearer. In one variation, the video screen may be protected by a transparent material, such as plastic. The pocket is preferably outwardly disposed so as to not interfere with the wearability of the belt. The video screen may be placed anywhere along the belt line. The belt may be worn across the waistline or in any other fashion. Moreover, the belt may be of any material that can support the load of the screen.

The video belt of this embodiment simply allows users to express their personal passions or other information via video in a real world environment. The video belt can be programmed by the user or preprogrammed by the manufacturer to display anything from popular culture icons, music videos, to sporting events, or virtually any other information that the consumer would like to display. Like the invention of the embroidery machine, the video belt allows people of all demographics to communicate information about themselves, in a fashion sense, on a whole new dynamic that has until now been unexplored.

The video belt, in one embodiment, includes a pocket PC that has been imbedded in a leather sleeve. This leather sleeve is visually tied into the art design of a stylized belt. The video belts, although ultimately produced in a myriad of styles and designs, all incorporate one or more of these pocket PCs. The pocket PC is preprogrammed to display the information the wearer chooses, as a personal statement or an advertising message. In the case of the latter, this message is strategically designed for maximum impact, with an understanding that the viewing public will most likely be sitting down in a restaurant or bar situation while viewing the belt display.

The belt's imagery may incorporate video or audio or a combination thereof, for example. Battery operated and self-contained, it is charged ahead of time with a self-contained charger that runs, for example, using a 12V power supply. The belt may then be activated and controlled via a touch sensitive screen that displays the data.

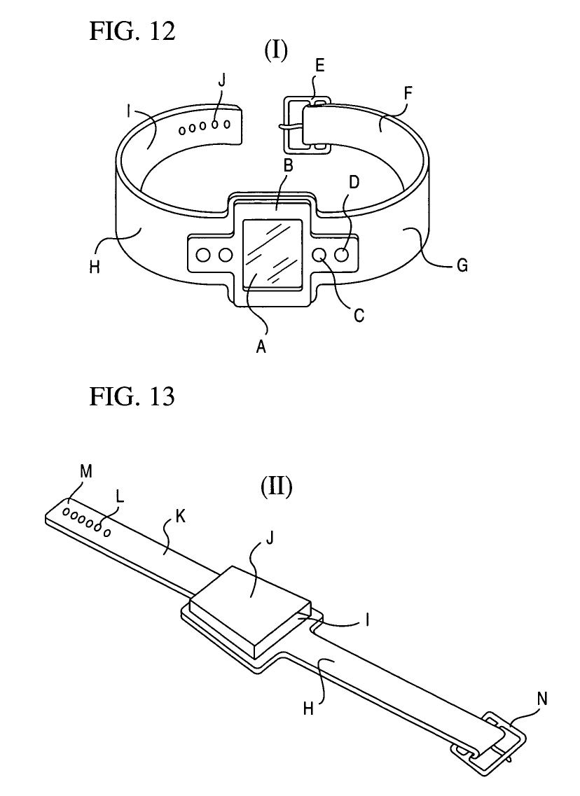

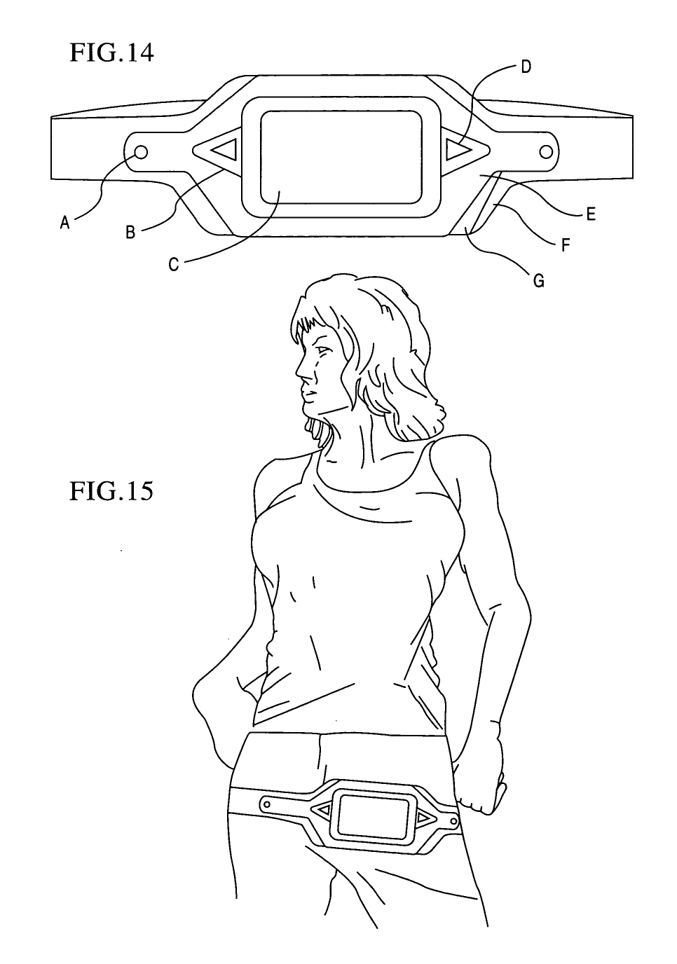

FIGS. 12 and 13 illustrate views of a first variation of a video belt in accordance with embodiments of the present invention. FIGS. 14 and 15 illustrate a second variation of a video belt in accordance with embodiments of the present invention.

Similar to the video belt, with regard to the video badge, there is an unmet need for entertainment producers, advertisers/promoters, and others to find new ways to reach audiences in an ever more competitive world bombarded by advertising. Using Las Vegas as an exemplary playing field, for example, there is a need for an invention that allows entertainers and others to advertise information, such as live theatrical productions, to potential ticket buyers in an intimate situation, away from the rest of the sea of advertisements already saturating Las Vegas. Specifically, there is a need for devices and methods to target the potential audience on the casino floor. There is a further need for such devices and methods to provide a psychological break from the digital noise already surrounding the public, such as may occur in the momentary interactions that take place between customers and casino employees, such as card dealers, waitresses, bartenders, and change makers.

These interactions provide an ideal opportunity to reach an audience. The video badge of the present invention serves as a solution for potential consumers to see a product for a few moments, focusing away from, for example, the rest of the additional stimuli that battle for attention on the casino floor. Applications of the present invention, however, reach far beyond the casinos of Las Vegas and in fact lie worldwide, wherever there is a consumer base and people to service them. Other exemplary uses include wearing by restaurant employees to promote menu special items, employees at banks to highlight an aspect of their financial services, and grocery workers to identify weekly specials (interchangeably referred to herein as providing a “primary service”).

Different from a conventional badge or printed sign, the video badge of the present invention allows for a virtually endless stream of information to be presented to consumers (interchangeably referred to herein as providing “secondary multimedia information”) by a retailer or service person in a very personal one-on-one situation. Because of the self-contained and very easy to operate nature of this product, it is conducive to use by untrained workers, as well as highly skilled staff and employees.

An embodiment of the video badge includes a color LCD display controlled by a processor (e.g., a microprocessor) that is run, for example, in a Windows® Pocket PC operating system. In this variation, images are stored in memory and displayed at a rate of about 24 frames per second. All power comes from, for example, an on board or remotely connected battery.

The video badge of this embodiment is a small self-contained device that includes a video screen that is capable of playing video and audio programming. In one embodiment, the video badge is approximately five inches high by three inches wide and less than one inch thick, and is designed to be lightweight and durable enough to withstand the conditions it faces while being worn both by consumers and retailers. Such retailers include service people, salesmen, waitresses, bartenders, bellboys, desk, clerks, concierges, hotel maids, valets, doormen, or virtually anyone working in retail stores and restaurants, resorts, food-service establishments, entertainment or any part of the tourism industry, as well as virtually anyone in the public eye holding any amount of visibility to consumers, who may wear this badge in order to send a message to consumers.

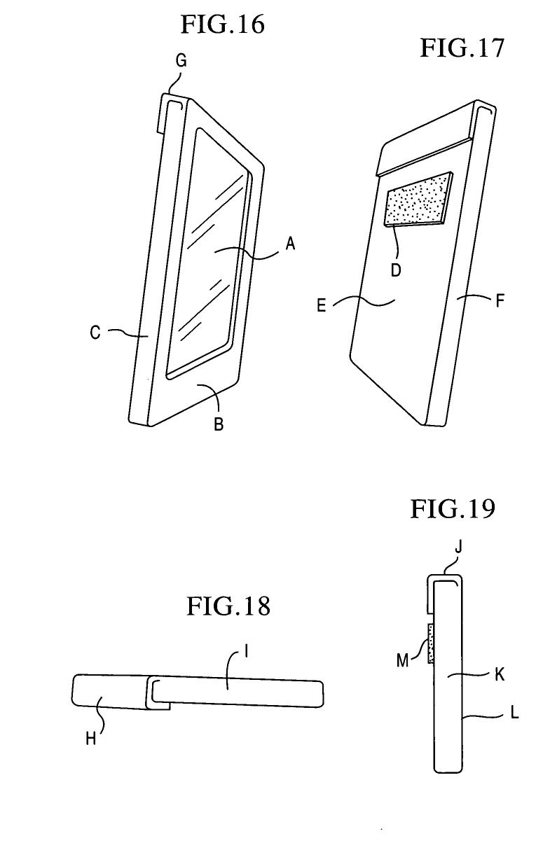

In one embodiment, as shown in FIGS. 16-19, the video badge includes a video display and media player that has been placed into a universal carrier designed to be fastened to a matable piece of clothing or accessory. The unit of this embodiment is fastenable to the wearer in a number of different ways, such as using Velcro®, snaps, buttons, pins, clips, magnets, or wire. The method of adhesion is variable, depending on the garment to which it is adhered. The electronics are self-contained with or within a battery pack, for example. The image is generated via a computer chip or other processor and is programmed ahead of time via, for example, a personal computer. The video programming is designed and formatted to conform to the orientation of the video badge. This may be vertical, horizontal, or at any angle desired.

In one embodiment, the video badge is recharged in its own charger which plugs into either 110 V AC, 12V DC, or 220V AC.

In developing nations, especially, the competition for advertising space is so fierce, that in many cases the styles and graphic approach to the outdoor advertising is actually not only affecting but defining the look of entire cities. As early as the turn of the previous century—with the construction of the Eiffel Tower—advertisements took their place in becoming emblematic icons of entire communities. The Eiffel Tower was originally intended as an advertising landmark for the Paris Exposition of 1889. In turn, New York's Times Square, as well as Tokyo's Ginza District or even Bangkok's Pat Pong area, are each refined by advertising, both architectural and temporary.

This never-ending competition continues to burn out of control, with advertisers still looking for new platforms. When one looks at an outdoor environment or even an indoor venue, one must keep in mind the rudimentary principles of the perception and the geometry of space. Quite simply, the further an advertising platform is away from the viewing customer, the smaller it becomes to human stereoscopic sight. It is this simple formula that gives the video badge power. Where an oversized video display is visible to a large number of people at any one time, the image is predominantly small, due to the distance from which it is viewed. In turn, the video badge, although relatively small in size, is viewed at very close range by the potential customer. When applying the geometry of perspective, the image size is virtually the same as the large displays, but at a fraction of the cost. In addition, because of this novelty, and because it is worn by another human being, the video badge lends itself as a vehicle for the most powerful form of advertising of all—word-of-mouth.

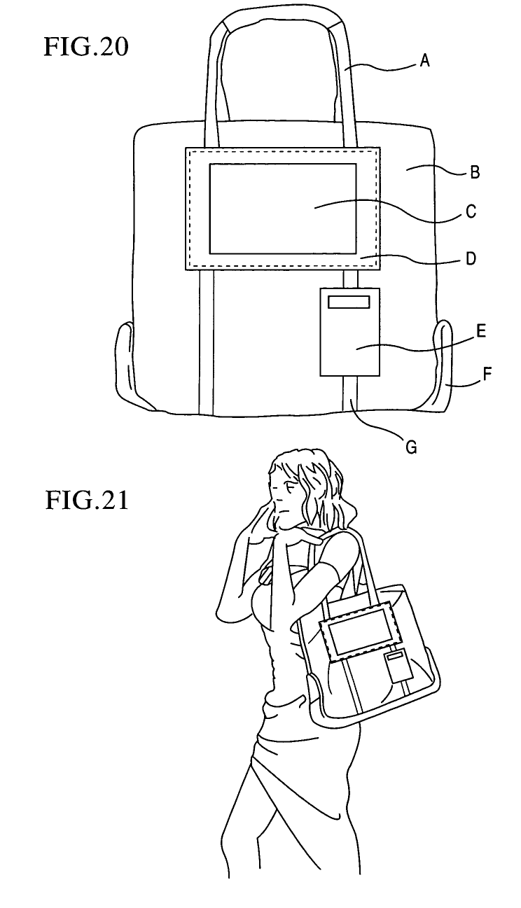

The video screen of the present invention may be secured to an array of other apparel, as well. One such embodiment of the present invention provides a first wearable video device, referred to interchangeably herein as a “video purse.” Variations of the video purse of the present invention are illustrated, for example, in FIGS. 20 and 21. In this embodiment, a purse (also known interchangeably herein as a “handbag”) contains a self-contained LCD video screen. The dimensions of the screen correspond to the dimensions of the handbag, wherein the screen cannot exceed the side of an outer wall of the handbag. Additional requirements concerning screen size are also dictated by fashion. In this embodiment, the LCD video screen is attached to a digital video disc (DVD) player, which is preprogrammable to play video/audio information. The DVD player allows the user to interchange DVD discs, thereby providing a virtually infinite amount of video display and correspondingly a virtually infinite amount of expression.

In one variation of the video purse, the DVD and video screen are secured to an inner wall of the purse. Accordingly, the video screen is disposed so that it faces the outside environment. This disposition allows the public to view the video and is intended as personal expression or public advertisement. In another variation, a transparent material, such as plastic, may be secured to at least one outer wall of the purse to allow the video screen to project video to the public while protecting the video screen from environmental elements.

In another variation of the video purse, the outer wall of the purse, preferably on the same wall as the video screen, includes access to the controls of the DVD player on the inside of the purse. In some embodiments, access is provided by a flap, door, removable and replaceable fabric, or any other device known in the art that allows access to the inside of the purse when opened and prevents access when closed.

The material of the purse may be any suitable material, including leather and canvas, for example, that provides the strength to secure the video screen to the bag and is able to support the weight of the screen and other contents of the purse. The shape (e.g., the dimensions of the wall) and overall design of the purse may be of any suitable type that allows accommodation of the video display and DVD unit.

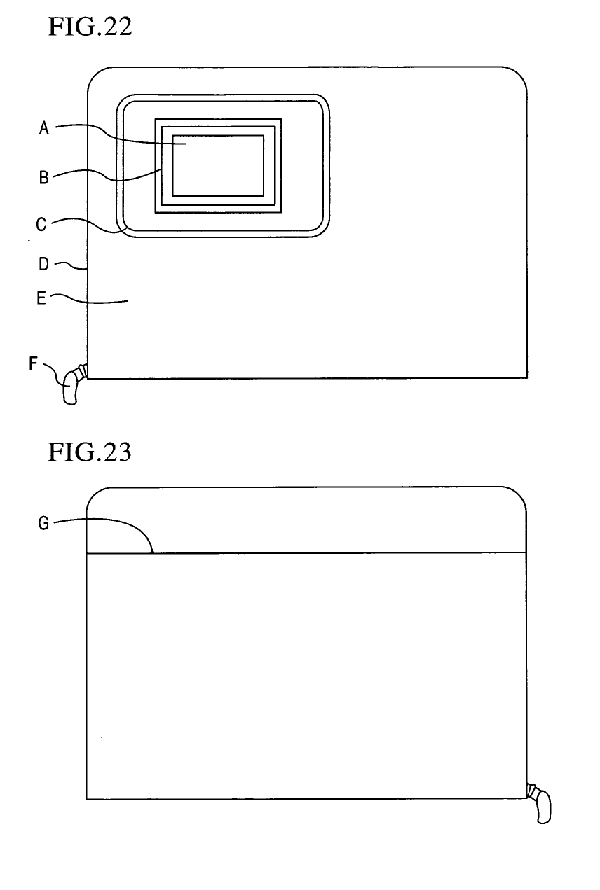

Another embodiment of the present invention, as shown in FIGS. 22 and 23, provides a wearable video device that is placed in a business folder (also interchangeably referred to herein as a “business portfolio,” “portfolio,” or “folder”). In this embodiment, the video outputting device is a portable LCD device, such as a personal digital assistant, or other handheld or other display device having dimensions to fit in a standard business portfolio. As DVD players and screens become increasingly smaller, the present invention can accommodate them in this and other embodiments. Larger portfolios can accommodate larger video devices, such as commonly available portable DVD players. As described with the portfolio embodiment, the video device may be of any type known in the art that is accommodatable in the apparel.

The portfolio is generally designed to have a book-like opening mechanism, wherein two faces of the portfolio are bound at one end. The two faces are further secured in a closed position by a locking device, such as a zipper, Velcro®, or buttons. In one variation, the portfolio includes a cut-out portion of material that corresponds to the size of the screen. At least one face of the portfolio includes a transparent material, such as plastic from which the video screen is seen by the public. The inner wall of the face securing the device includes a securing mechanism, such as a stitched pocket or general retaining holder that keeps the video screen in place, disposed so that the video can be seen through the cut out portion of the portfolio. It should be noted that the video portfolio can be made of any suitable material, such as leather, plastic or cloth, as long as, for example, the material is resilient enough to hold the video device in place.

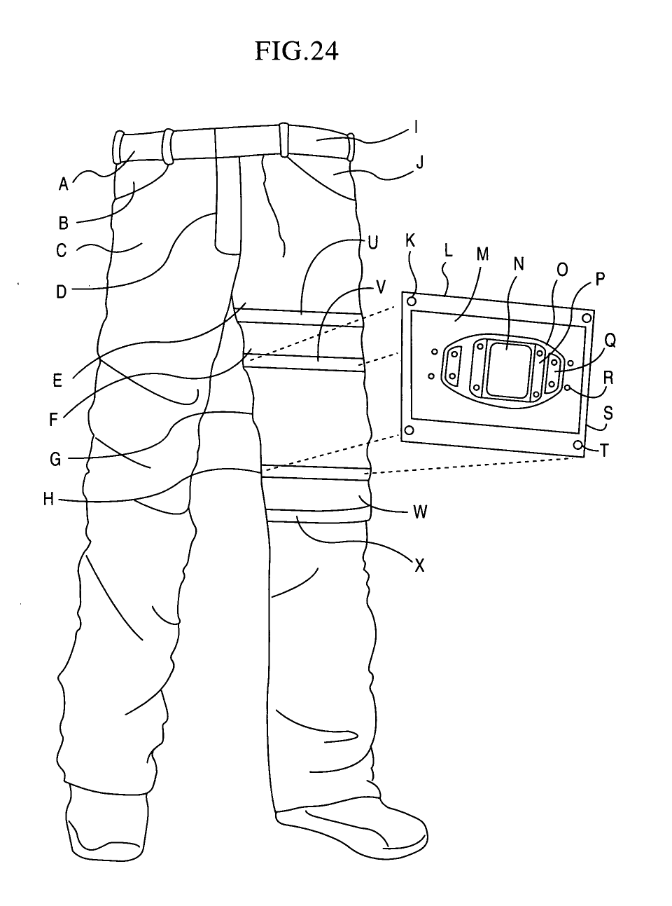

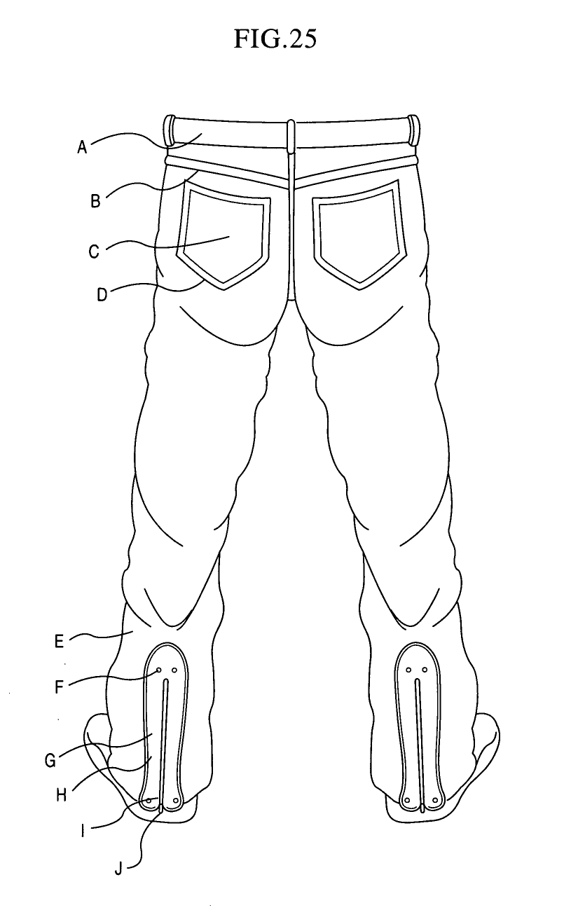

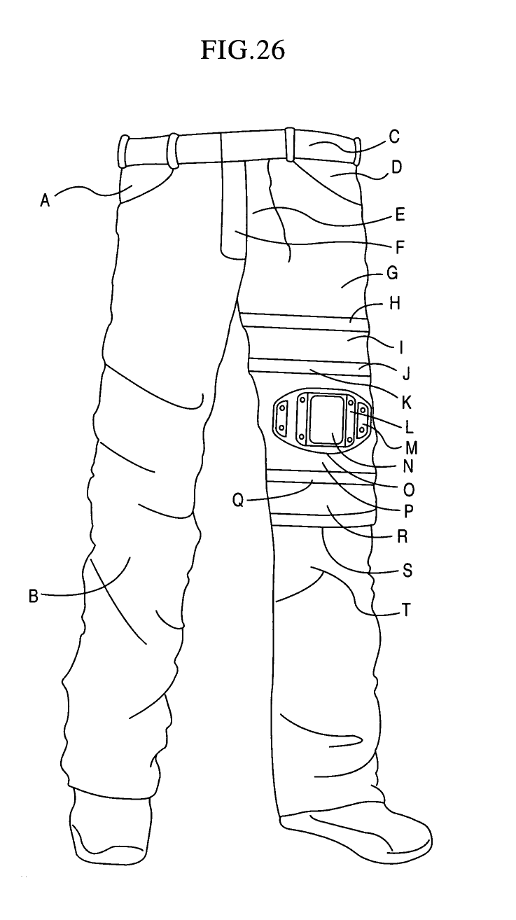

FIGS. 24-26 illustrate other variations, wherein the video is secured to trousers (also interchangeably referred to herein as “jeans” or “pants”). The pants can be made of any material known in the art, such as leather, denim, or cotton. The material must be able to retain the video screen in place and support the load of the screen. In FIG. 24, for example, the video screen is secured in an outwardly disposed pocket having a transparent plastic protector. Generally, in each variation of the embodiments of FIGS. 24-26, the apparel includes reinforced material to keep the video screen sufficiently in place. Reinforcement is accomplished using stitched material, fasteners or other devices.

It should be noted that the wearable video device of the present invention could be attached to any other apparel or accessory that can accommodate a video screen. It is envisioned that as video screens become increasingly smaller, the application of the present invention will extend to smaller accessories and lightweight apparel that can accommodate the weight of smaller video screens. It should be further noted that aesthetic and fashion-oriented features on the apparel and accessories, as illustrated by example in the figures, that are unrelated to the securing and displaying of the video screen, are intended to be exemplary.

Among other advantages, the present invention enables individuals to be expressive. In one variation, the video displayed on the screen is selected by the individual wearing the video screen and can be reflective of the individual's personality, mood, or thoughts. The present invention thereby also advances the field of fashion and design.

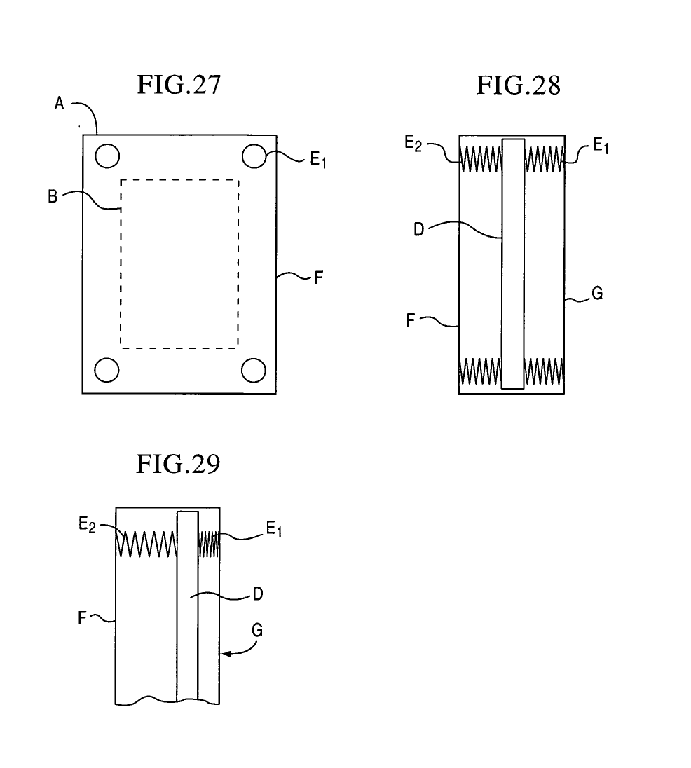

There is a need for the present invention to be durable in order to allow the user to enjoy a long-lasting and efficient mechanism and system for advertising and/or self-expression. Because of the nature of the present invention, there is the likelihood that the invention will be exposed to the normal daily contacts with hard or rough surfaces (e.g., the wearer leaning the wall), as is typically experienced by any other apparel. As shown in FIGS. 27-36, embodiments of the present invention include features to appropriately absorb such potential impacts.

The impact absorbing features of some embodiments of the present invention allow the rigidity of the outside enclosure and the display to be maintained separately, while a shock absorbing mechanism disposed between the enclosure and display allows relative flexible movement of these two portions. In each variation of the impact absorbing features, the display component, to which the electronic circuitry board is attached, is contained in an enclosure component comprised of any suitably durable and/or lightweight material, such as plastic. For example, a front portion of the enclosure component may include a rigid opaque outer frame and a transparent membrane (window) within the frame in order to allow the display component to be viewed through the membrane, and the back portion of the enclosure may include a one-piece rigid section that completely encloses the back portion of the display component. A biasing mechanism is disposed between the enclosure component portions and the display component, allowing the display component to move flexibly, yet return to a predetermined position, while sandwichably contained within the enclosure portions. A number of biasing mechanisms may be used with the present invention.

In one variation, as shown in FIGS. 27-29, the biasing mechanism includes one or more flexible units E₁, E₂, such as springs, disposed between the display component D and the front F and back G portions of the enclosure component. The front enclosure portion may include a frame section A and a window section B. FIG. 29 shows the display component D at a flexed position relative to the front F and back G portions of the enclosure component; the biasing mechanisms E₁, E₂ tend to bias the display component D to an initial position, such as centrally located between the front F and back G portions of the enclosure component.

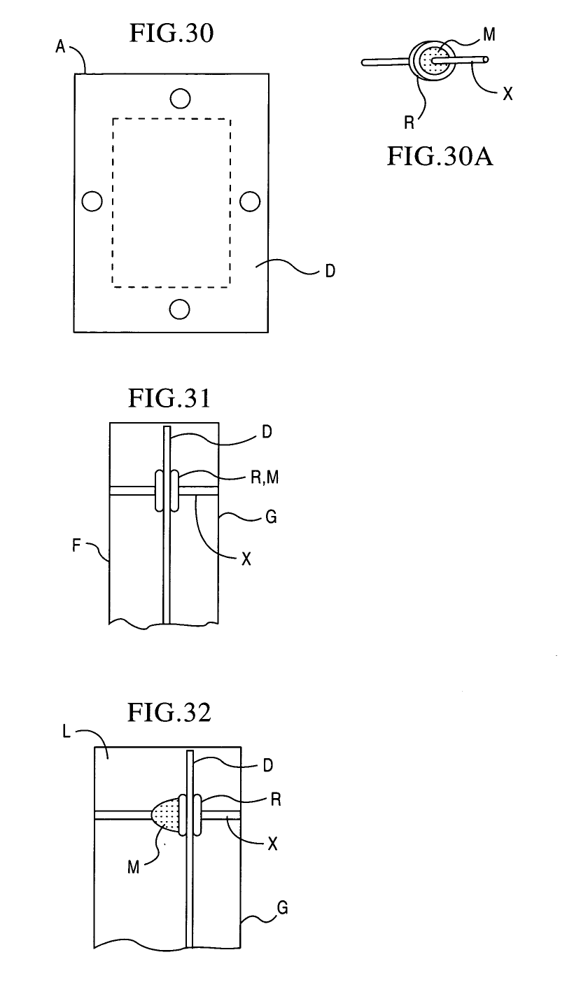

FIGS. 30-32 show a similar variation to that in FIGS. 27-29, but that use biasing units having a donut or gasket configuration. In the embodiments of FIGS. 30-32, a flexible membrane M, such as plastic or rubber, spans a rim portion R. Extending through and attached to the membrane M is an axle X. The axle X is rigidly attached to the front F and back G portions of the enclosure component. The rim portion R of the biasing units, which may, for example, have an outer circular shape, each have an outer groove or otherwise are designed to attach to the display component D, such as by fitting within an opening in a board portion of the display component D. This implementation allows the display component to be biased, along the rod, from any position within the enclosure component, to a predetermined position because of the flexible nature of the membrane. FIG. 32 shows this embodiment with the display component D displaced relative to the front F and back G portions of the enclosure component.

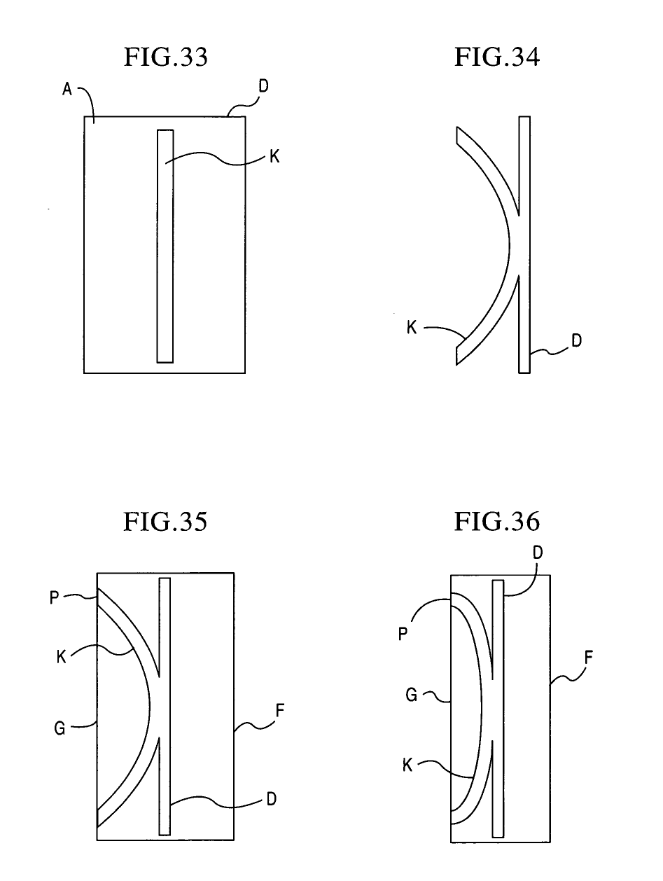

In yet another variation, the biasing mechanism is comprised of one or more lever elements, as shown in FIGS. 33-36. In one variation, the biasing mechanism K extends from the display component D and is attached to the back portion G of the enclosure component. In this variation, the biasing mechanism K is, for example, molded into the back portion of the display component D and then attached to the back portion G of the enclosure component, such as at a single point P. FIG. 35 shows the biasing mechanism K attached to the display component D and one leg of the biasing mechanism K attached to the back portion G of the enclosure component in an undisplaced position. In FIG. 36, the display component D has been displaced relative to the back G and front F portions of the enclosure component, with the unattached leg of the biasing mechanism K has flexibly displaced along the back portion G of the enclosure portion, biasedly opposing the displacement of the display component D. It should be noted that this variation could employ as many biasing mechanisms as desired, disposed in multiple locations on the display unit, and that such biasing mechanisms could extend toward either the back or the front of the enclosure component, or in both directions.

There is a further need for comfort when wearing the present invention, and the user should not be exposed to any extreme temperature as a result of wearing the devices of the present invention. Every electronic device, such as the present display component, dissipates heat; therefore, there is a need to decrease this heat dissipation to a level that will not create discomfort and hence, impinge on the work of the user. There is also a need to minimize the level of heat of the display component in order to keep it from overheating. The human body also naturally dissipates heat, so there is a need to prevent this additional heat dissipation from affecting the functionality of the present invention.

Embodiments of the present invention promote comfort for the wearing user, as well as maintain the display device at a low heat level, by, for example, providing highly integrated components and utilizing multiple function components to reduce the number of components required. The amount of power consumption is therefore decreased, which in turn decreases the amount of heat dissipation. Among the additional advantages of using fewer components are increase in battery life and decrease in overall weight of the present invention.

The highly integrated and multifunctional components also allow a wide range of sources of multimedia information to be flexibly utilized (e.g., via multiple input mechanisms, such as DVD capability, a universal service bus (USB) port, flash memory capability, and a wireless port, contained within the device) and to allow the device to be easily transported, set up, and operated absent an electrical outlet or other separate power supply. This configuration also provides a certain caché for the user, similar to the compact and attractive presentation of other handheld devices, such as the iPod made by Apple of Cupertino, Calif.

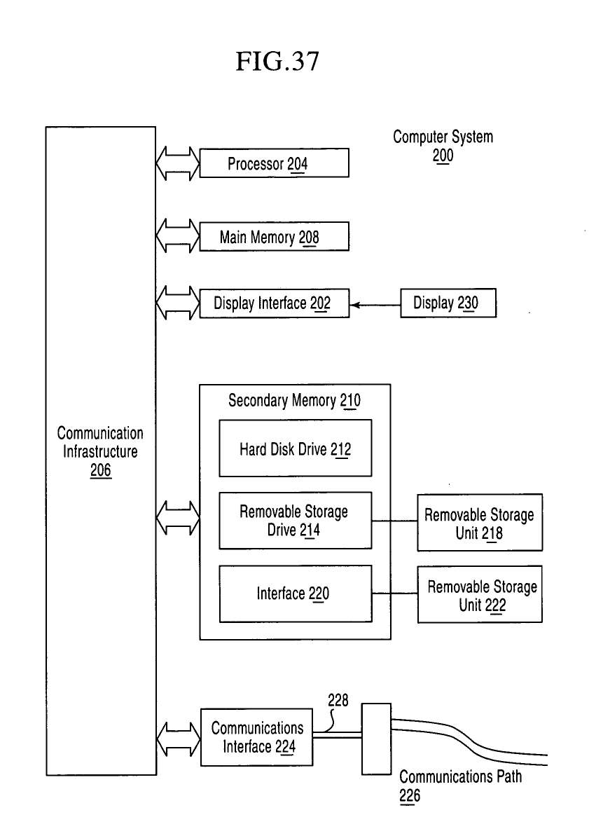

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 37.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Example embodiments of the present invention have now been described in accordance with the above advantages. It will be appreciated that these examples are merely illustrative of the invention. Many variations and modifications will be apparent to those skilled in the art.

1. A compact and self-contained multimedia presentation device capable of being worn by an individual, the device comprising:
an enclosure component;
a multimedia presentation component contained within the enclosure component;
a multimedia information processing and storage component coupled to the multimedia presentation component; and
a plurality of multimedia input mechanisms for deliverying multimedia information to the multimedia information processing and storage component.

2. The device of claim 1, wherein the device is wearably attachable to clothing.

3. The device of claim 1, wherein the multimedia presentation component includes a display device.

4. The device of claim 1, wherein the plurality of multimedia input mechanisms include at least two selected from a group consisting of a digital video disk player, a universal service bus port, a wireless receiver, and a flash memory device.

5. The device of claim 1, further comprising:
a biasing mechanism connecting the enclosure component and the multimedia presentation component.

6. The device of claim 5, wherein the biasing mechanism comprises at least one selected from a group consisting of a spring, a flexible membrane, and a molded extension.

7. The device of claim 1, wherein the multimedia information processing and storage component includes a minimal number of multiuse semiconductor elements so as to produce less heat than separate use semiconductor elements.

8. A video badge device, comprising:
a badge component;
an enclosure component attached to the badge component;
a display component contained within the enclosure component; and
a display information source coupled to the display component for delivery of multimedia content to the display component.

9. The video badge of claim 8, further comprising:
a fastening device.

10. The video badge of claim 9, wherein the fastening device is selected from a group consisting of Velcro®, snaps, buttons, pins, clips, magnets and wire.

11. The video badge of claim 8, further comprising:
a biasing mechanism disposed between the enclosure component and the display component.

12. The video badge of claim 11, wherein the biasing mechanism biases the display component at a first location within the enclosure component.

13. A video belt device, comprising:
a belt component;
an enclosure component attached to the belt component;
a display component contained within the enclosure component; and
a display information source coupled to the display component for delivery of multimedia content to the display component.

14. The video belt of claim 13, wherein the enclosure component comprises plastic.

15. The video belt of claim 13, further comprising:
a biasing mechanism disposed between the enclosure component and the display component

16. The video belt of claim 15, wherein the biasing mechanism biases the display component at a first location within the enclosure component.

17. A video purse, comprising:
a purse having at least one outer side;
an enclosure component attached to the purse;
a display component contained within the enclosure component and capable of being viewed via the at least one outer side of the purse; and
a display information source coupled to the display component for delivery of multimedia content to the display component.

18. The video purse of claim 17, further comprising:
a display information source controller within the purse.

19. The video purse of claim 18, wherein the display information source controller is accessable via an opening in the at least one outer side of the purse.

20. A video portfolio, comprising:
a portfolio having at least one outer side;
an enclosure component attached to the portfolio;
a display component contained within the enclosure component and capable of being viewed via the at least one outer side of the portfolio; and
a display information source coupled to the display component for delivery of multimedia content to the display component.
